(19) United States
(12) Patent Application Publication
(10) Pub. No.: US 2024/0306133 A1
(43) Pub. Date: Sep. 12, 2024

(54) METHOD FOR PERFORMING ENHANCED PREAMBLE PUNCTURING IN WIRELESS COMMUNICATION SYSTEM WITH AID OF SOFT PUNCTURING AND COHERENT PUNCTURING CONTROL, AND ASSOCIATED APPARATUS

(71) Applicant: MEDIATEK INC., Hsin-Chu (TW)

(72) Inventor: Cheng-Yi Chang, Hsinchu City (TW)

(73) Assignee: MEDIATEK INC., Hsin-Chu (TW)

(21) Appl. No.: 18/596,604

(22) Filed: Mar. 5, 2024

Related U.S. Application Data
(60) Provisional application No. 63/488,535, filed on Mar. 6, 2023.
(60) Provisional application No. 63/488,537, filed on Mar. 6, 2023.

(51) Int. Cl. H04W 72/0453; H04L 5/00

(52) U.S. Cl. CPC H04W 72/0453; H04L 5/0053; H04L 5/0094

(57) ABSTRACT

A method for performing enhanced preamble puncturing in a wireless communication system and associated apparatus are provided. The wireless communication system may include a first wireless transceiver device having an enhanced preamble puncturing capability, where the first wireless transceiver device is configured to operate in a first transmission bandwidth including one primary and multiple non-primary channels. The method may include: determining at least one interfered channel in at least one of the primary and non-primary channels; and performing the enhanced preamble puncturing on transmission of physical layer (PHY) protocol data units (PPDUs) including transmitting, in the aforementioned at least one interfered channel, at least one first PHY protocol data unit (PPDU) configured to have a lower power than a power of other PPDUs transmitted in other primary or non-primary channels.

### CROSS REFERENCE TO RELATED APPLICATIONS

This application claims the benefit of U.S. Provisional Application No. 63/488,535, filed on Mar. 6, 2023. Further, this application claims the benefit of U.S. Provisional Application No. 63/488,537, filed on Mar. 6, 2023. The contents of these applications are incorporated herein by reference.

### BACKGROUND

The present invention is related to communication control, and more particularly, to a method for performing enhanced preamble puncturing in a wireless communication system, and associated apparatus such as a wireless transceiver device (e.g., an access point (AP) device or a station (STA) device) in the wireless communication system.

According to the related art, a wireless communication system such as a Wi-Fi system may be very crowded in many circumstances, and the performance may be degraded severely in some scenarios such as dense overlapping basic service set (OBSS) or wireless scenarios, especially for the bandwidth efficiency with wider bandwidth configurations.

FIG. 1A shows an example of channel operation of an access point (AP) 101 in 802.11ac system, where the AP 101 supports a 80 MHz bandwidth by aggregation of four 20 MHz channels, of which channel 52 is the primary channel, and other 20 MHz channels 56, 60 and 64 are non-primary (or, secondary) channels. When a channel interference occurs, the AP 101 transmitting on the whole 80 MHz channel may be interfered by traffic from nearby APs or STAs on channel 56. As a result, the AP 101 may fall back to transmitting on its primary channel 52, e.g. 20 MHz primary channel, instead of suspending transmission on the entire 80 MHz channel. Thus, in IEEE 802.11ax Standard, a conventional preamble puncturing technology was introduced to increase the bandwidth efficiency of channel access, especially when experiencing interference.

As shown in FIG. 1B, this conventional preamble puncturing allows an AP 102 supporting 802.11ax to puncture the interfered non-primary channel and transmit data on the other 20 MHz channels. As shown in the FIG. 1B, the AP 102 shields/skips channel 56 and communicates on channel 52, 60 and 64. However, this conventional preamble puncturing exists some constraints; for instance, the interfered channel, e.g. the punctured channel 56 in FIG. 1B, would be occupied by other devices for an unexpected long time. In another extreme case where the primary channel is interfered, the AP allocated with the whole 80 MHz bandwidth may not be able to transmit at all because the primary channel may not be punctured in conventional preamble puncturing. Thus, an AP/STA may lose the opportunities to access the channel with its maximum bandwidth capability while applying preamble puncturing. Consequently, a novel method and associated architecture are needed for solving the problems without introducing any side effect or in a way that is less likely to introduce a side effect.

### SUMMARY

It is an objective of the present invention to provide a method for performing enhanced preamble puncturing in a wireless communication system, and associated apparatus such as wireless transceiver devices (e.g., one or more AP devices and one or more non-access-point (non-AP) STA devices) in the wireless communication system, in order to solve the above-mentioned problems.

At least one embodiment of the present invention provides a method for performing enhanced preamble puncturing in a wireless communication system, where the wireless communication system may comprise a first wireless transceiver device having an enhanced preamble puncturing capability, where the first wireless transceiver device is configured to operate in a first transmission bandwidth comprising one primary and multiple non-primary channels. The method may comprise: determining at least one interfered channel in at least one of the primary and non-primary channels; and performing the enhanced preamble puncturing on transmission of physical layer (PHY) protocol data units (PPDUs) comprising transmitting, in the aforementioned at least one interfered channel, at least one first PHY protocol data unit (PPDU) configured to have a lower power than a power of other PPDUs transmitted in other primary or non-primary channels. According to some embodiments, performing the enhanced preamble puncturing on the transmission of the PPDUs may further comprise performing the enhanced preamble puncturing with coherent puncturing control on any first PPDU among the aforementioned at least one first PPDU, for aligning a first transmission opportunity (TXOP) duration of the any first PPDU to a TXOP duration of an OBSS PPDU. For example, the coherent puncturing control may comprise controlling the first TXOP duration to make the any first PPDU be ended just before the OBSS PPDU is ended, for gaining one or more wider bandwidth channel access opportunities.

At least one embodiment of the present invention provides a wireless transceiver device for performing enhanced preamble puncturing in a wireless communication system such as that mentioned above, where the wireless transceiver device may be one of multiple devices within the wireless communication system. The wireless communication system may comprise the wireless transceiver device having an enhanced preamble puncturing capability, where the wireless transceiver device is configured to operate in a first transmission bandwidth comprising one primary and multiple non-primary channels. The wireless transceiver device may comprise a processing circuit that is arranged to control operations of the wireless transceiver device. The wireless transceiver device may further comprise at least one communication control circuit that is coupled to the processing circuit and arranged to perform communication control, where the aforementioned at least one communication control circuit is arranged to perform wireless communication operations with at least one other device (e.g., another wireless transceiver device) among the multiple devices within the wireless communication system for the wireless transceiver device. For example, the aforementioned at least one other device may be wirelessly linking to the wireless transceiver device. In addition, the wireless transceiver device may be arranged to determine at least one interfered channel in at least one of the primary and non-primary channels; and the wireless transceiver device is arranged to perform the enhanced preamble puncturing on transmission of PPDUs comprising transmitting, in the aforementioned at least one interfered channel, at least one first PPDU configured to have a lower power than a power of other PPDUs transmitted in other primary or non-primary channels.

It is an advantage of the present invention that, through proper design, the present invention method, as well as the associated apparatus such as the wireless transceiver devices (e.g., the one or more AP devices and the one or more non-AP STA devices) in the wireless communication system, can perform enhanced puncturing control regarding preamble puncturing, such as soft puncturing and coherent puncturing, to increase the opportunities of wider bandwidth channel access, in order to access the spectrum dynamically for system performance enhancement in dense wireless scenarios. In addition, the present invention method and apparatus can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A illustrates an example of the channel operation of an access point (AP) in the 802.11ac system.

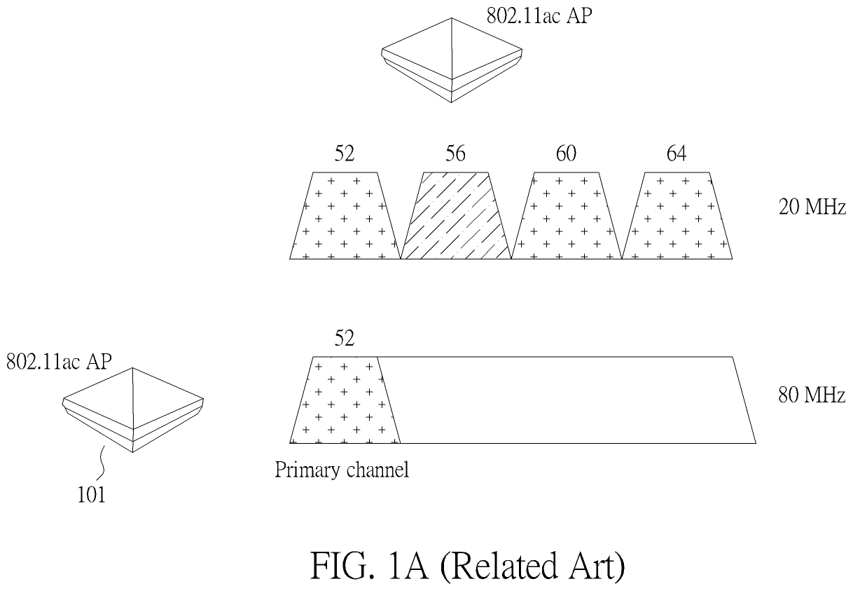

FIG. 1B illustrates a conventional preamble puncturing which allows an AP supporting 802.11ax to puncture the interfered non-primary channel and transmit data on the other 20 MHz channels.

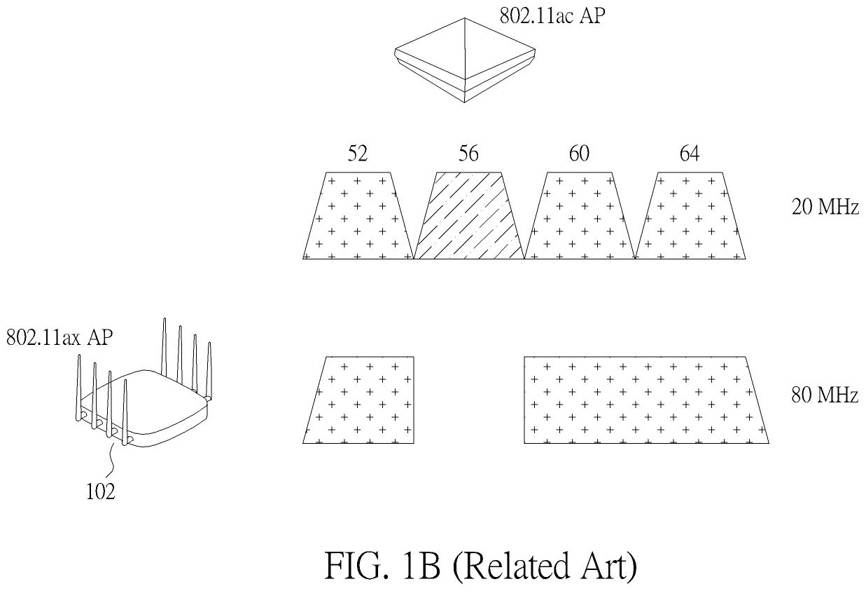

FIG. 2 is a diagram of a wireless communication system according to an embodiment of the present invention.

FIG. 3 illustrates, in the right half part thereof, a soft puncturing control scheme of a method for performing enhanced preamble puncturing in a wireless communication system according to an embodiment of the present invention, where a hard puncturing control scheme may be illustrated in the left half part of FIG. 3 for better comprehension.

FIG. 4 illustrates some implementation details of the soft puncturing control scheme shown in FIG. 3 regarding a special case that a primary channel among a set of 20 MHz channels is configured as a soft punctured channel according to an embodiment of the present invention.

FIG. 5 illustrates, in the lower half part thereof, a non-primary-channel soft puncturing control scheme of the method according to an embodiment of the present invention, where a non-primary-channel hard puncturing control scheme may be illustrated in the upper half part of FIG. 5 for better comprehension.

FIG. 6 illustrates, in the lower half part thereof, a primary-channel soft puncturing control scheme of the method according to an embodiment of the present invention, where a primary-channel hard puncturing control scheme may be illustrated in the upper half part of FIG. 6 for better comprehension.

FIG. 7 illustrates, in the lower half part thereof, a first coherent puncturing control scheme of the method regarding a special case that adjacent channel interfere exists on a non-primary channel among a set of 20 MHz channels according to an embodiment of the present invention, where a first non-coherent puncturing control scheme may be illustrated in the upper half part of FIG. 7 for better comprehension.

FIG. 8 illustrates, in the lower half part thereof, a second coherent puncturing control scheme of the method regarding a special case that primary channel interfere exists on a primary channel among a set of 20 MHz channels according to an embodiment of the present invention, where a second non-coherent puncturing control scheme may be illustrated in the upper half part of FIG. 8 for better comprehension.

FIG. 9 illustrates, in the upper half part and the lower half part thereof, a third coherent puncturing control scheme and a fourth coherent puncturing control scheme of the method according to an embodiment of the present invention.

FIG. 10 illustrates a working flow of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

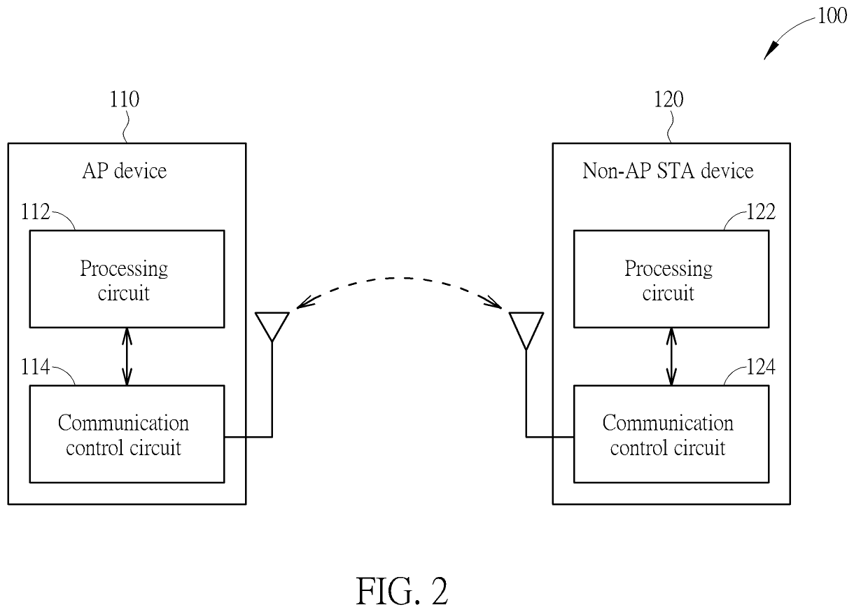

FIG. 2 is a diagram of a wireless communication system 100 according to an embodiment of the present invention. For better comprehension, the wireless communication system 100, as well as any wireless transceiver device #n among multiple wireless transceiver devices #1, . . . and #N therein, may be compatible or backward-compatible to one or more versions of the Institute of Electrical and Electronics Engineers (IEEE) 802.11 standards, but the present invention is not limited thereto. Regarding the multiple wireless transceiver devices #1, . . . and #N within the wireless communication system 100, a wireless transceiver device among them may be implemented as an AP device 110, and another transceiver device among them may be implemented as a non-AP STA device 120, but the present invention is not limited thereto. For example, two or more wireless transceiver devices among the multiple wireless transceiver devices #1, . . . and #N may be implemented as multiple AP devices {110}. For another example, two or more wireless transceiver devices among the multiple wireless transceiver devices #1, . . . and #N may be implemented as multiple non-AP STA devices {120}. In some examples, two or more wireless transceiver devices among the multiple wireless transceiver devices #1, . . . and #N may be implemented as multiple AP devices {110}, and two or more other wireless transceiver devices among the multiple wireless transceiver devices #1, . . . and #N may be implemented as multiple non-AP STA devices {120}.

As shown in FIG. 2, the AP device 110 may comprise a processing circuit 112, at least one communication control circuit (e.g., one or more communication control circuits), which may be collectively referred to as the communication control circuit 114, and at least one antenna (e.g., one or more antennas) of the communication control circuit 114, and the non-AP STA device 120 may comprise a processing circuit 122, at least one communication control circuit (e.g., one or more communication control circuits), which may be collectively referred to as the communication control circuit 124, and at least one antenna (e.g., one or more antennas) of the communication control circuit 124. In the architecture shown in FIG. 2, the processing circuit 112 can be arranged to control operations of the AP device 110, and the communication control circuit 114 can be arranged to perform communication control, and more particularly, perform wireless communication operations with the network (or at least one other device therein such as the non-AP STA device 120) for the AP device 110. In addition, the processing circuit 122 can be arranged to control operations of the non-AP STA device 120, and the communication control circuit 124 can be arranged to perform communication control, and more particularly, perform wireless communication operations with the network (or at least one other device therein such as the AP device 110) for the non-AP STA device 120.

According to some embodiments, the processing circuit 112 can be implemented by way of at least one processor/microprocessor, at least one random access memory (RAM), at least one bus, etc., and the communication control circuit 114 can be implemented by way of at least one wireless network control circuit and at least one wired network control circuit, but the present invention is not limited thereto. Examples of the AP device 110 may include, but are not limited to: a Wi-Fi router. In addition, the processing circuit 122 can be implemented by way of at least one processor/microprocessor, at least one RAM, at least one bus, etc., and the communication control circuit 124 can be implemented by way of at least one wireless network control circuit, but the present invention is not limited thereto. Examples of the non-AP STA device 120 may include, but are not limited to: a multifunctional mobile phone, a laptop computer, an all-in-one computer and a wearable device.

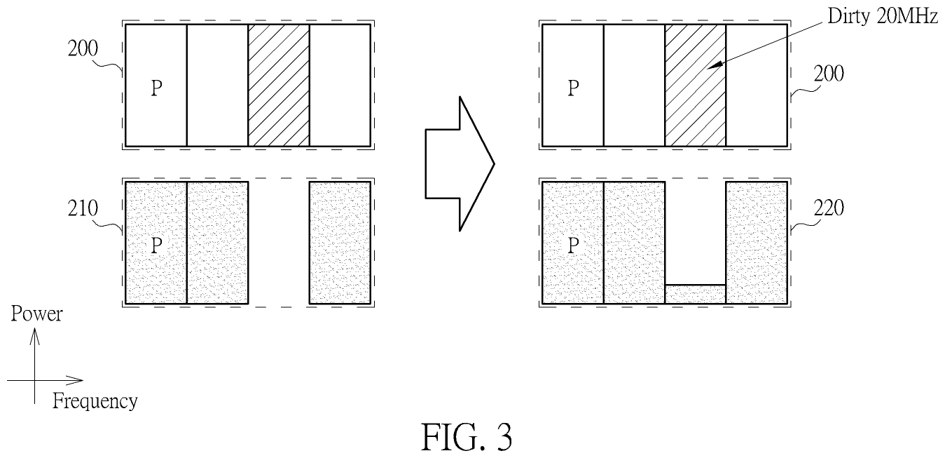

FIG. 3 illustrates, in the right half part thereof, a soft puncturing control scheme of a method for performing enhanced preamble puncturing in a wireless communication system according to an embodiment of the present invention, where a hard puncturing control scheme may be illustrated in the left half part of FIG. 3 for better comprehension. The method can be applied to the wireless transceiver device #n having an enhanced preamble puncturing capability and configured to operate in a first transmission bandwidth comprising one primary and multiple non-primary channels, such as the AP device 110, and can be applied to at least one other wireless transceiver device #n′, such as the non-AP STA device 120 and/or another AP device among the multiple AP devices {110}, for performing the enhanced preamble puncturing in the wireless communication system 100, and the associated operations of the wireless communication system 100 operating according to the method may comprise:
(1) the wireless communication system 100 may utilize the AP device 110 (or the communication control circuit 114 therein) to determine at least one interfered channel in at least one of the primary and non-primary channels, where the AP device 110 may perform handshaking with the aforementioned at least one other wireless transceiver device n′ (e.g., the non-AP STA device 120 and/or the other AP device among the multiple AP devices {110}) in advance, and more particularly, send at least one indication for indicating at least one capability regarding the enhanced preamble puncturing, for performing communication via the primary and non-primary channels; and
(2) the wireless communication system 100 may utilize the AP device 110 (or the communication control circuit 114 therein) to perform the enhanced preamble puncturing on transmission of PPDUs, comprising transmitting, in the aforementioned at least one interfered channel, at least one first PPDU configured to have a lower power than a power of other PPDUs transmitted in other primary or non-primary channels;
   where the aforementioned at least one interfered channel may comprise one or more 20 megahertz (20 MHz) channels such as one or more 20 MHz bandwidth (BW20) channels, and the aforementioned at least one first PPDU may comprise one or more signals on the one or more 20 MHz channels. For example, the primary and non-primary channels may be implemented as multiple 20 MHz channels (or multiple BW20 channels), and each 20 MHz channel among the multiple 20 MHz channels may correspond to a minimum bandwidth (e.g., a BW20) among multiple predetermined bandwidths, but the present invention is not limited thereto. In some examples, the primary and non-primary channels may be implemented as multiple non-20 MHz channels, such as multiple 40 MHz channels (or multiple 40 MHz bandwidth (BW40) channels), multiple 80 MHz channels (or multiple 80 MHz bandwidth (BW80) channels), etc. In addition, the AP device 110 can be taken as an example of the wireless transceiver device #n, and the non-AP STA device 120 and/or the other AP device among the multiple AP devices {110} can be taken as examples of the aforementioned at least one other wireless transceiver device #n′, but the present invention is not limited thereto. When the non-AP STA device 120 and the AP device 110 are taken as examples of the wireless transceiver device #n and the aforementioned at least one other wireless transceiver device #n′, respectively, the associated operations of the wireless communication system 100 operating according to the method may comprise:
(1) the wireless communication system 100 may utilize the non-AP STA device 120 (or the communication control circuit 124 therein) to determine the aforementioned at least one interfered channel in the aforementioned at least one of the primary and non-primary channels, where the non-AP STA device 120 may perform handshaking with the aforementioned at least one other wireless transceiver device n′ (e.g., the AP device 110) in advance, and more particularly, send at least one indication for indicating at least one capability regarding the enhanced preamble puncturing, for performing the communication via the primary and non-primary channels; and
(2) the wireless communication system 100 may utilize the non-AP STA device 120 (or the communication control circuit 124 therein) to perform the enhanced preamble puncturing on the transmission of the PPDUs, comprising transmitting, in the aforementioned at least one interfered channel, the aforementioned at least one first PPDU configured to have the lower power than the power of the other PPDUs transmitted in the other primary or non-primary channels.

For better comprehension, assume that one or more functions of the wireless communication system 100 may be temporarily disabled to allow the AP device 110 and the non-AP STA device 120 to operate according to the hard puncturing control scheme shown in the left half part of FIG. 3, and the horizontal axis and the vertical axis may represent the frequency and the power, respectively, but the present invention is not limited thereto. Based on the hard puncturing control scheme, the AP device 110 may perform the preamble puncturing to enhance the bandwidth efficiency, especially when experiencing OBSS interference, but perform the preamble puncturing according to the hard puncturing control scheme may reduce the opportunities to access the channel with wider bandwidth. More particularly, the AP device 110 may perform the preamble puncturing on a PPDU 210 regarding the dirty 20 MHz channel on a BW20 when experiencing the OBSS interference due to an OBSS PPDU 200. There are some constraints of the hard puncturing control scheme, such as a first constraint that the dirty 20 MHz (or BW20) channel may be occupied by an OBSS device such as a device in an OBSS, and a second constraint that the AP device 110 cannot puncture the dirty 20 MHz channel when the dirty 20 MHz channel is the primary channel (labeled “P” for brevity) such as the primary 20 MHz (or BW20) channel.

As shown in the right half part of FIG. 3, the wireless communication system 100 (or the AP device 110 and the non-AP STA device 120 therein) may operate according to the soft puncturing control scheme to achieve better overall performance, and more particularly, perform the enhanced preamble puncturing, such as the preamble puncturing with soft puncturing control (or “the soft puncturing”), to increase the wider bandwidth channel access opportunities while applying the preamble puncturing. During the enhanced preamble puncturing, the one or more signals on the one or more soft punctured 20 MHz channels may be transmitted with the lower power, where the lower power may comprise at least one lower transmit power that is lower than any transmit power of any signals on any other 20 MHz channels within the primary and non-primary channels. For example, the primary and non-primary channels may comprise a set of 20 MHz channels (e.g., four BW20 channels) on the BW80, and the one or more soft punctured 20 MHz channels may comprise a first soft punctured 20 MHz channel such as the soft punctured BW20 channel. The AP device 110 may perform the enhanced preamble puncturing on the first PPDU such as the PPDU 220 regarding the dirty 20 MHz (or BW20) channel, even for a special case that the dirty 20 MHz channel is the primary channel such as the primary 20 MHz (or BW20) channel. The AP device 110 may transmit the same preamble and add padding into the PHY service data unit (PSDU) with (or via) dummy bits to occupy the one or more soft punctured 20 MHz channels such as the punctured 20 MHz (or BW20) channels with lower transmit power, where the transmitted PPDU such as the first PPDU (e.g., the PPDU 220) may be softly punctured, which means the AP device 110 may have still transmitted the one or more signals in the one or more soft punctured 20 MHz channels such as the punctured 20 MHZ (or BW20) channels.

In the embodiment shown in FIG. 3, the wireless transceiver device #n such as the AP device 110 may have the enhanced preamble puncturing capability, and may be configured to operate in the first transmission bandwidth such as the BW80. The one primary channel may represent one 20 MHz channel (e.g., one BW20 channel) used as the primary 20 MHz channel among the set of 20 MHz channels (e.g., the four BW20 channels) on the BW80, and the multiple non-primary channels may represent the other 20 MHz channels (e.g., the three other BW20 channels) among the set of 20 MHz channels (e.g., the four BW20 channels) on the BW80. In addition, the wireless transceiver device #n such as the AP device 110 may select a greater bandwidth that is greater than the minimum bandwidth (e.g., the BW20) from the multiple predetermined bandwidths to be the first transmission bandwidth. Examples of the greater bandwidth may include, but are not limited to: at least one BW80, at least one 160 MHz bandwidth (BW160), at least one 320 MHz bandwidth (BW320), etc. According to the embodiment shown in FIG. 3, the first transmission bandwidth may be the BW80, but the present invention is not limited thereto. According to some embodiments, the first transmission bandwidth may vary.

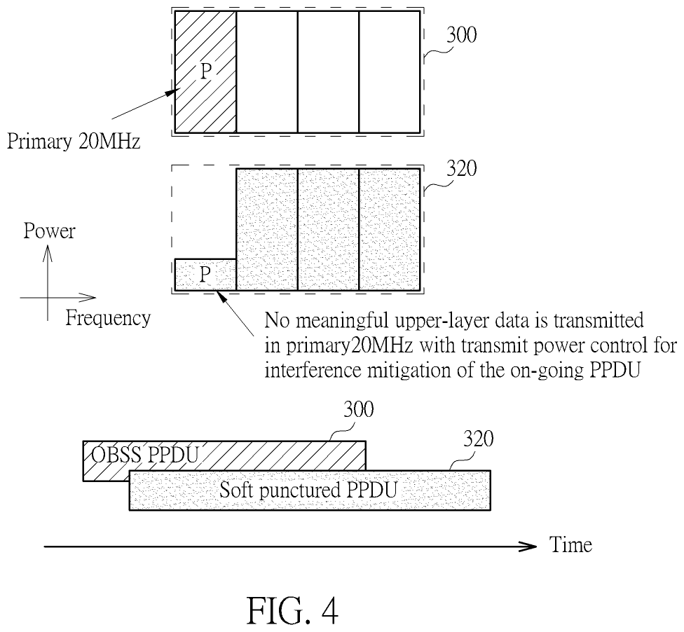

FIG. 4 illustrates some implementation details of the soft puncturing control scheme shown in FIG. 3 regarding a special case that the primary channel among the set of 20 MHz channels (e.g., four BW20 channels) within the primary and non-primary channels is configured as a soft punctured channel according to an embodiment of the present invention. In the special case, when the dirty 20 MHz channel is the primary channel such as the primary 20 MHz channel, the OBSS PPDU 300 and the soft punctured PPDU 320 may be illustrated as shown in FIG. 4 to replace the OBSS PPDU 200 and the PPDU 220 shown in FIG. 3, respectively. During the enhanced preamble puncturing, no meaningful upper-layer data will be transmitted in the first soft punctured 20 MHz channel (e.g., the soft punctured BW20 channel) among the one or more soft punctured 20 MHz channels. More particularly, the first soft punctured 20 MHz channel such as the soft punctured BW20 channel may represent the primary channel among the set of 20 MHz channels (e.g., the four BW20 channels). During the enhanced preamble puncturing, the aforementioned at least one first PPDU may be configured to have a predetermined data portion transmitted in the primary channel among the one or more 20 MHz channels. For example, the predetermined data portion may include zero-padded bits or dummy bits. In addition, the one or more signals on the one or more soft punctured 20 MHz channels may comprise a first signal on the first soft punctured 20 MHz channel (e.g., the soft punctured BW20 channel) among the one or more soft punctured 20 MHz channels, and the first signal may be transmitted with the transmit power control for the mitigation (or the interference mitigation) of at least one on-going PPDU (such as the OBSS PPDU 300) transmitted from the OBSS that causes the determination of the aforementioned at least one interfered channel.

Based on the soft puncturing control scheme, no matter whether it is the special case or not, the enhanced preamble puncturing (or the soft puncturing control thereof) may comprise controlling the one or more signals on the one or more soft punctured 20 MHz channels as one or more low power signals while performing the enhanced preamble puncturing regarding the one or more soft punctured 20 MHz channels, where any transmit power of the one or more low power signals is lower than the aforementioned any transmit power of the aforementioned any signals on the aforementioned any other 20 MHz channel within the primary and non-primary channels. More particularly, the one or more signals such as the one or more low power signals may comprise the same preamble contents as that of the aforementioned any signals on the aforementioned any other 20 MHz channels which are not soft punctured, and the predetermined data portion may comprise the aforementioned same preamble contents. In addition, the one or more signals such as the one or more low power signals may have at least one preamble signaling content which is different from at least one corresponding preamble content of the aforementioned any signals on the aforementioned any other 20 MHz channels which are not soft punctured, and the predetermined data portion may comprise the aforementioned at least one preamble signaling content. For example, the aforementioned at least one preamble signaling content may comprise one or a combination of a field value in a high efficiency (HE) SIGNAL/signal B (HE-SIG-B) field within a first PHY header of the first PPDU (e.g., the PPDU 220 or the PPDU 320) and a field value in an extremely high throughput (EHT) SIGNAL/signal (EHT-SIG) field within the first PHY header. Additionally, the one or more signals such as the one or more low power signals may have one or more PSDUs with dummy bits. The one or more low power signals may have at least one preamble during the whole of any first PPDU among the aforementioned at least one first PPDU (e.g., the entire PPDU 220 or the entire PPDU 320), where the predetermined data portion may comprise the aforementioned at least one preamble, and the aforementioned at least one preamble may comprise a repeated content which is repeated and is the same as a preamble content of the aforementioned any signal on the aforementioned any other 20 MHz channel which is not soft punctured, but the present invention is not limited thereto. For example, the aforementioned at least one preamble may comprise a repeated content which is repeated and is the same as a partial content among multiple partial contents of the preamble content of the aforementioned any signal on the aforementioned any other 20 MHz channel which is not soft punctured. Regarding the special case mentioned above, the first soft punctured 20 MHz channel (e.g., the soft punctured BW20 channel) among the one or more soft punctured 20 MHz channels may represent the primary channel among the set of 20 MHz channels (e.g., the four BW20 channels) within the primary and non-primary channels, but the present invention is not limited thereto. For example, the aforementioned at least one interfered channel may include a 40 megahertz (40 MHz) primary channel, and the aforementioned at least one first PPDU, transmitting in the aforementioned at least one interfered channel, may have a preamble having repeated fields, where the repeated fields may be L-STF fields, and each L-STF field among the L-STF fields may be the same as a L-STF field in a PPDU transmitted in at least one other 20 MHz channel. For another example, the aforementioned at least one interfered channel may include the 40 MHz primary channel, and the aforementioned at least one first PPDU, transmitting in the aforementioned at least one interfered channel, may have a plurality of repeated preambles.

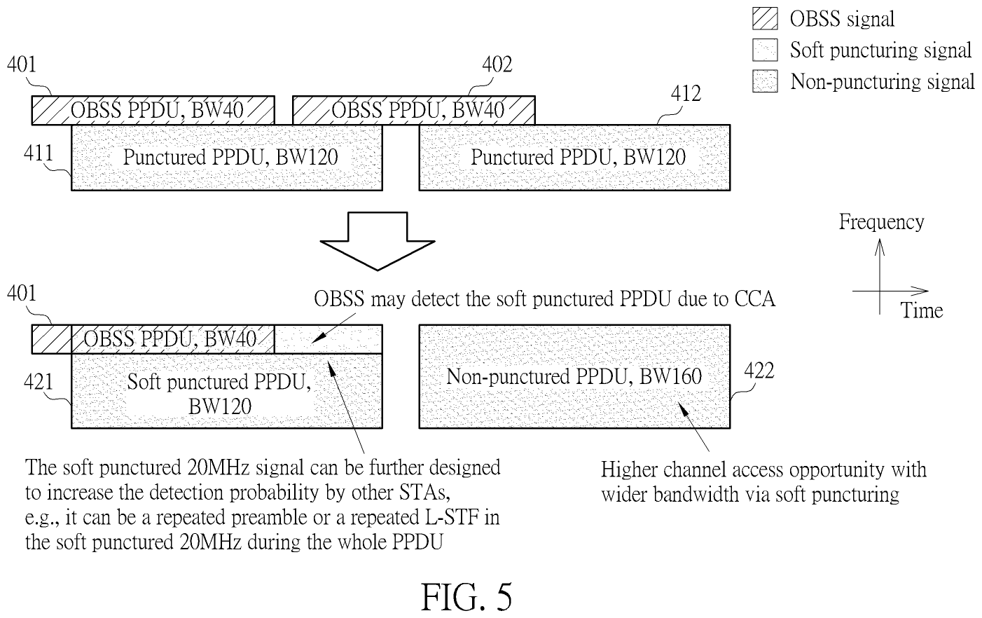

FIG. 5 illustrates, in the lower half part thereof, a non-primary-channel soft puncturing control scheme of the method according to an embodiment of the present invention, where a non-primary-channel hard puncturing control scheme may be illustrated in the upper half part of FIG. 5 for better comprehension. Assume that one or more functions of the wireless communication system 100 may be temporarily disabled to allow the AP device 110 and the non-AP STA device 120 to operate according to the non-primary-channel hard puncturing control scheme shown in the upper half part of FIG. 5, and the horizontal axis and the vertical axis may represent the time and the frequency, respectively, but the present invention is not limited thereto. Based on the non-primary-channel hard puncturing control scheme, when detecting an OBSS PPDU 401 on a BW40 channel corresponding to the BW40, the AP device 110 may perform the preamble puncturing on a punctured PPDU 411 regarding the BW40 channel corresponding to the BW40 to make the punctured PPDU 411 merely occupy the remaining channels (e.g., the other three BW40 channels) corresponding to a 120 MHz bandwidth (BW120), to allow a subsequent OBSS PPDU 402 on the BW40 channel to have a chance to be transmitted; and when detecting the OBSS PPDU 402 on the BW40 channel corresponding to the BW40, the AP device 110 may perform the preamble puncturing on a punctured PPDU 412 regarding the BW40 channel corresponding to the BW40 to make the punctured PPDU 411 merely occupy the remaining channels (e.g., the other three BW40 channels) corresponding to the BW120, to allow another subsequent OBSS PPDU on the BW40 channel to have a chance to be transmitted; and the rest can be deduced by analogy.

As shown in the lower half part of FIG. 5, the wireless communication system 100 (or the AP device 110 and the non-AP STA device 120 therein) may operate according to the non-primary-channel soft puncturing control scheme to achieve better overall performance, and more particularly, perform the enhanced preamble puncturing to increase the wider bandwidth channel access opportunities while applying the preamble puncturing. During the enhanced preamble puncturing, the one or more signals on the one or more soft punctured 20 MHz channels, such as the soft puncturing signals on the BW40, may be transmitted with the lower transmit power that is lower than the transmit power of the non-puncturing signals on the BW120. For example, when detecting the OBSS PPDU 401 on the BW40 channel corresponding to the BW40, the AP device 110 may perform the enhanced preamble puncturing on a soft punctured PPDU 421 regarding the BW40 channel corresponding to the BW40 to make the punctured PPDU 421 occupy both of the BW40 channel corresponding to the BW40 and the remaining channels (e.g., the other three BW40 channels) corresponding to the BW120, to prevent any subsequent OBSS PPDU (e.g., the subsequent OBSS PPDU 402) on the BW40 channel from being transmitted, since the OBSS may detect the soft punctured PPDU 421 due to clear channel assessment (CCA). The soft puncturing signals on the BW40 may comprise two soft punctured 20 MHz (or BW20) signals on two 20 MHz bandwidths within the BW40, and each soft punctured 20 MHz signal among the two soft punctured 20 MHz signals can be further designed to increase the detection probability by other STAs, for example, the soft punctured 20 MHz signal can be a repeated preamble or a repeated L-STF (or non-high-throughput (Non-HT) Short Training field) of the PHY preamble in the soft punctured 20 MHz (or BW20) channel corresponding to the BW20 during the whole PPDU 421. As no subsequent OBSS PPDU (e.g., the subsequent OBSS PPDU 402) on the BW40 channel is transmitted, the AP device 110 may transmit a non-punctured PPDU 422 on the whole BW160. When operating according to the method, the AP device 110 can obtain a higher channel access opportunity with a wider bandwidth via the soft puncturing.

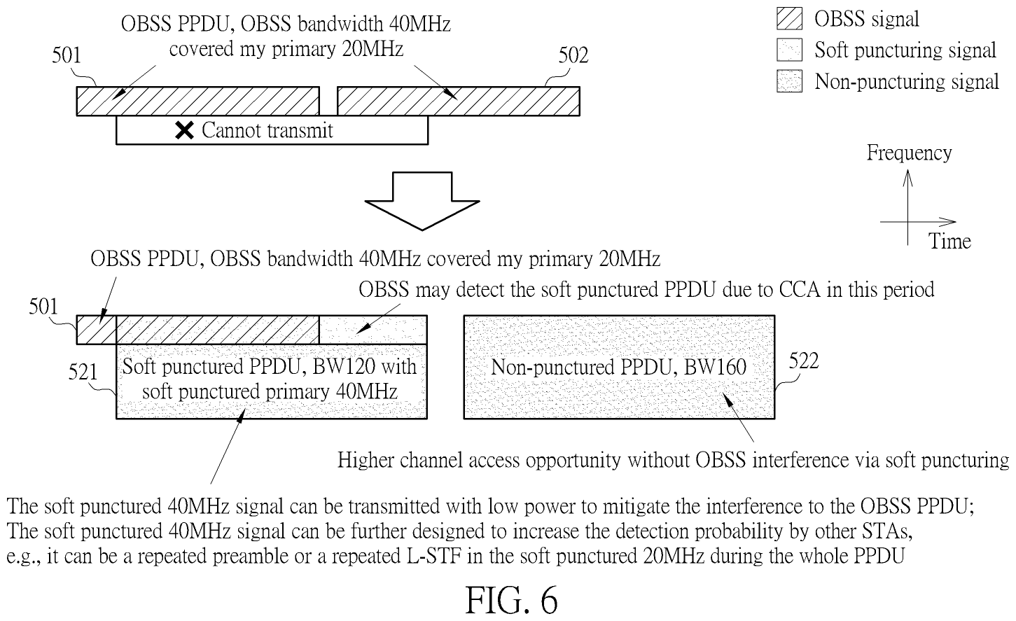

FIG. 6 illustrates, in the lower half part thereof, a primary-channel soft puncturing control scheme of the method according to an embodiment of the present invention, where a primary-channel hard puncturing control scheme may be illustrated in the upper half part of FIG. 6 for better comprehension. Assume that one or more functions of the wireless communication system 100 may be temporarily disabled to allow the AP device 110 and the non-AP STA device 120 to operate according to the primary-channel hard puncturing control scheme shown in the upper half part of FIG. 6, and the horizontal axis and the vertical axis may represent the time and the frequency, respectively, but the present invention is not limited thereto. Based on the primary-channel hard puncturing control scheme, when detecting an OBSS PPDU 501 on an OBSS bandwidth such as a 40 MHz bandwidth covered the primary channel such as the primary 20 MHz channel (or “my primary 20 MHz”), the AP device 110 operating according to the primary-channel hard puncturing control scheme cannot transmit any PPDU.

As shown in the lower half part of FIG. 6, the wireless communication system 100 (or the AP device 110 and the non-AP STA device 120 therein) may operate according to the primary-channel soft puncturing control scheme to achieve better overall performance, and more particularly, perform the enhanced preamble puncturing to increase the wider bandwidth channel access opportunities while applying the preamble puncturing. During the enhanced preamble puncturing, the one or more signals on the one or more soft punctured 20 MHz channels, such as the soft puncturing signals on the BW40, may be transmitted with the lower transmit power that is lower than the transmit power of the non-puncturing signals on the BW120. For example, when detecting the OBSS PPDU 501 on the BW40 channel corresponding to the BW40, the AP device 110 may perform the enhanced preamble puncturing on a soft punctured PPDU 521 regarding the BW40 channel corresponding to the BW40 to make the punctured PPDU 521 occupy both of the BW40 channel corresponding to the BW40 and the remaining channels (e.g., the other three BW40 channels) corresponding to the BW120, to prevent any subsequent OBSS PPDU (e.g., the subsequent OBSS PPDU 502) on the BW40 channel from being transmitted, since the OBSS may detect the soft punctured PPDU 421 due to CCA in this period. The soft puncturing signals on the BW40 may be regarded as the soft punctured 40 MHz (or BW40) signal on the BW40, and the soft punctured 40 MHz signal can be transmitted with the low power to mitigate the interference to the OBSS PPDU 501, and can be further designed to increase the detection probability by other STAs, for example, the soft punctured 40 MHz signal can be a repeated preamble or a repeated L-STF of the PHY preamble in the soft punctured 20 MHz (or BW20) channel corresponding to the BW20 during the whole PPDU 521. As no subsequent OBSS PPDU (e.g., the subsequent OBSS PPDU 502) on the BW40 channel is transmitted, the AP device 110 may transmit a non-punctured PPDU 522 on the whole BW160. When operating according to the method, the AP device 110 can obtain a higher channel access opportunity without OBSS interference via the soft puncturing.

Some implementation details of the protocol and the PPDU design for the soft-punctured PPDU may be further described as follows. For example, during the handshaking such as the capability handshaking, the wireless transceiver device #n and the aforementioned at least one other wireless transceiver device #n′ in the wireless communication system 100, such as the AP device 110 and the non-AP STA device 120, can be arranged to transmit and receive at least one capability field to support the soft puncturing, where the aforementioned at least one capability field can be defined in the PHY capability element, but the present invention is not limited thereto. In some examples, during the handshaking such as the capability handshaking, the wireless transceiver device #n and the aforementioned at least one other wireless transceiver device #n′ in the wireless communication system 100, such as the AP device 110 and the non-AP STA device 120, can be arranged to specify the preamble structures to support soft puncturing, where the associated field can be defined in the PHY capability element. Regarding the preamble, the hard/soft/no punctured information such as the information indicating the hard puncturing or the soft puncturing or no puncturing shall be specified in the PPDU. For example, the information of hard/no punctured information may be defined in the U-SIG (or universal signal) punctured channel information field, and there may be some options of the implementation as follows:
(Option A1): extend the punctured channel information field (e.g., the punctured channel information field used in a previous version of the IEEE 802.11 standards) to specify the soft punctured information;
(Option A2): regard the soft punctured as hard punctured in the current punctured channel information field (e.g., the punctured channel information field used in the previous version of the IEEE 802.11 standards) and define another field in the U-SIG to specify the soft/hard punctured information; and
(Option A3): regard the soft punctured as no punctured in the current punctured channel information field (e.g., the punctured channel information field used in the previous version of the IEEE 802.11 standards) and define another field in the U-SIG to specify the no/soft punctured information;
   but the present invention is not limited thereto. In some examples, the options of the implementation may vary. In addition, the soft punctured 20 MHz (or the soft punctured 20 MHz bandwidth) can be arranged to provide the information in the PPDU, and there may be some options of the implementation as follows:
(Option B1): just transmit the dummy signals to occupy the channels in the soft punctured 20 MHz (or the soft punctured 20 MHz bandwidth), and more particularly, to prevent other devices to access the channel;
(Option B2): transmit the same preamble as the un-punctured part of the PPDU, for example, transmit the dummy bits in the soft punctured 20 MHz of the PSDU; and
(Option B3): transmit the repeated L-STFs or repeated preamble in the soft-punctured 20 MHz, to prevent other devices from accessing the channel;
   but the present invention is not limited thereto. In some examples, the options of the implementation may vary.

According to some embodiments, the wireless transceiver device #n and the aforementioned at least one other wireless transceiver device #n′ in the wireless communication system 100, such as the AP device 110 and the non-AP STA device 120, can be arranged to perform the enhanced preamble puncturing with coherent puncturing control (or “the coherent puncturing”) to increase the opportunities of higher bandwidth efficiency while applying the preamble puncturing, where the “coherent” of the coherent puncturing control means to be aware of the interference duration. More particularly, performing the enhanced preamble puncturing on the transmission of the PPDUs may further comprise performing the enhanced preamble puncturing with the coherent puncturing control on any first PPDU among the aforementioned at least one first PPDU, for aligning a first TXOP duration of the any first PPDU to a TXOP duration of an OBSS PPDU. For example, the coherent puncturing control may comprise controlling the first TXOP duration to make the any first PPDU be ended just before (or slightly before) the OBSS PPDU is ended, for gaining one or more wider bandwidth channel access opportunities. In addition, the coherent puncturing control may further comprise estimating the TXOP duration of the OBSS PPDU according to at least one preamble content of the OBSS PPDU. For example, the aforementioned at least one preamble content may comprise one or a combination of a field value in a Non-HT SIGNAL/signal (L-SIG) field within an OBSS PHY header of the OBSS PPDU, a field value in a HE SIGNAL/signal A (HE-SIG-A) field within the OBSS PHY header, and a field value in the EHT-SIG field within the OBSS PHY header. Additionally, the coherent puncturing control may further comprise aligning the first TXOP duration of the any first PPDU to the TXOP duration of the OBSS PPDU which occupied a primary channel among a set of 20 MHz channels within the primary and non-primary channels.

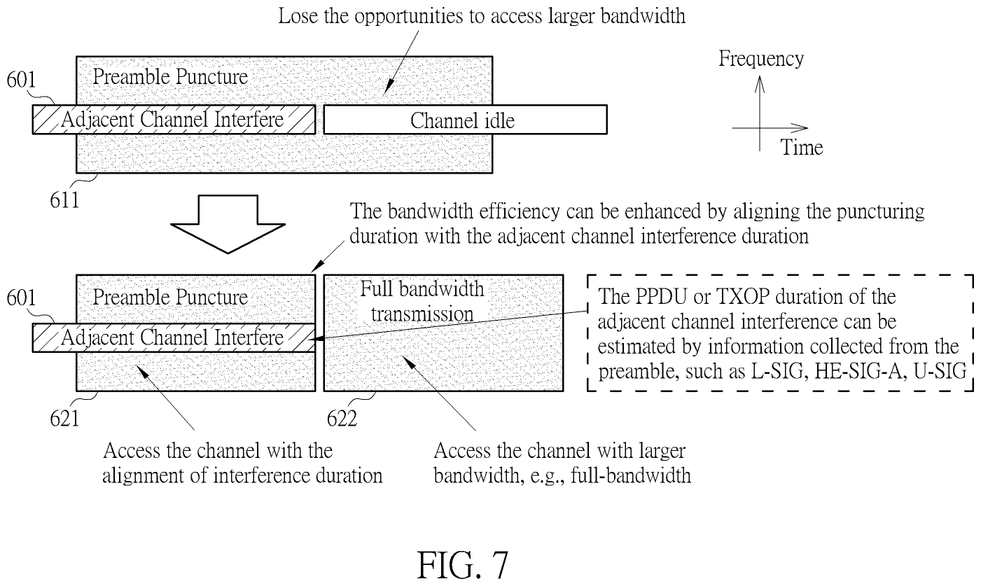

FIG. 7 illustrates, in the lower half part thereof, a first coherent puncturing control scheme of the method regarding a special case that adjacent channel interfere exists on a non-primary channel among a set of 20 MHz channels (e.g., BW20 channels) according to an embodiment of the present invention, where a first non-coherent puncturing control scheme may be illustrated in the upper half part of FIG. 7 for better comprehension. Assume that one or more functions of the wireless communication system 100 may be temporarily disabled to allow the AP device 110 and the non-AP STA device 120 to operate according to the first non-coherent puncturing control scheme shown in the upper half part of FIG. 7, and the horizontal axis and the vertical axis may represent the time and the frequency, respectively, but the present invention is not limited thereto. Based on the first non-coherent puncturing control scheme, when detecting the adjacent channel interfere 601 (e.g., the adjacent channel interfere due to an OBSS PPDU) on an OBSS bandwidth such as a 40 MHz bandwidth that may have covered at least one non-primary channel, the AP device 110 may perform the preamble puncturing on a punctured PPDU 611 regarding the aforementioned at least one non-primary channel corresponding to the OBSS bandwidth (labeled “Preamble Puncture” for brevity), and keep the aforementioned at least one non-primary channel idle, and therefore lose the opportunities to access a larger bandwidth.

As shown in the lower half part of FIG. 7, the wireless communication system 100 (or the AP device 110 and the non-AP STA device 120 therein) may operate according to the first coherent puncturing control scheme to achieve better overall performance, and more particularly, perform the preamble puncturing with the coherent puncturing to increase the wider bandwidth channel access opportunities while applying the preamble puncturing. The AP device 110 may perform the preamble puncturing with the coherent puncturing on the first PPDU such as the PPDU 621 (labeled “Preamble Puncture” for brevity) to access the channel(s) with the alignment of the interference duration, for example, by aligning the puncturing duration with the adjacent channel interference duration such as the duration of the adjacent channel interference, and further perform the full bandwidth transmission of the subsequent PPDU 622 (labeled “Full bandwidth transmission” for brevity) to access the channel(s) with a larger bandwidth such as the full bandwidth. As a result, the bandwidth efficiency can be enhanced by aligning the puncturing duration with the adjacent channel interference duration. In addition, the PPDU (e.g., the OBSS PPDU) or the TXOP duration of the adjacent channel interference can be estimated by the information collected from the preamble, such as the information (or the field value) in any field among the L-SIG field, the HE-SIG-A field and the U-SIG field. For brevity, similar descriptions for this embodiment are not repeated in detail here.

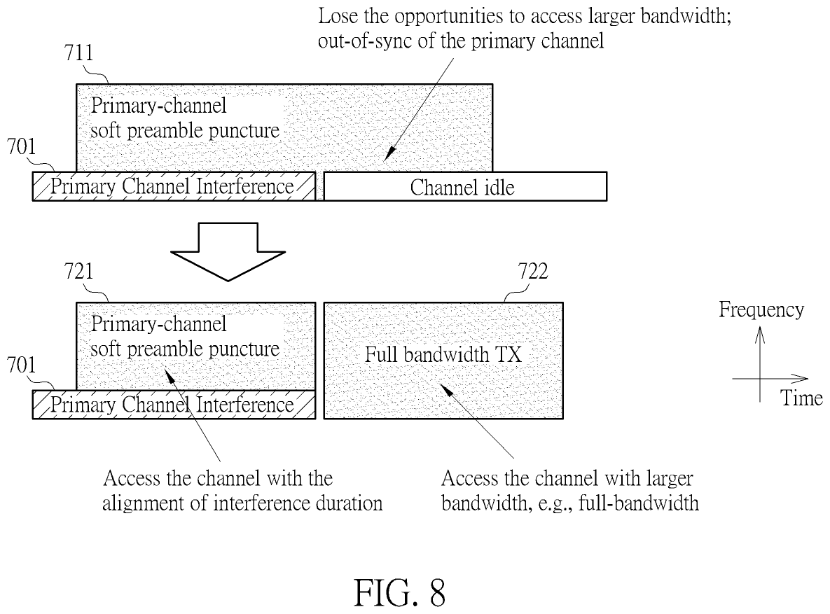

FIG. 8 illustrates, in the lower half part thereof, a second coherent puncturing control scheme of the method regarding a special case that primary channel interfere exists on a primary channel among a set of 20 MHz channels (e.g., BW20 channels) according to an embodiment of the present invention, where a second non-coherent puncturing control scheme may be illustrated in the upper half part of FIG. 8 for better comprehension. Assume that one or more functions of the wireless communication system 100 may be temporarily disabled to allow the AP device 110 and the non-AP STA device 120 to operate according to the second non-coherent puncturing control scheme shown in the upper half part of FIG. 8, and the horizontal axis and the vertical axis may represent the time and the frequency, respectively, but the present invention is not limited thereto. Based on the second non-coherent puncturing control scheme, when detecting the primary channel interfere 701 (e.g., the adjacent channel interfere due to an OBSS PPDU) on an OBSS bandwidth such as a 40 MHz bandwidth that may have covered a primary channel, the AP device 110 may perform the enhanced preamble puncturing, such as the preamble puncturing with the soft puncturing or simply the hard puncturing, on a punctured PPDU 711 regarding the aforementioned at least one non-primary channel corresponding to the OBSS bandwidth (labeled “Primary-channel soft preamble puncture” for brevity), and keep at least the primary channel idle, and therefore lose the opportunities to access a larger bandwidth and further encounter the problem of out-of-sync of the primary channel.

As shown in the lower half part of FIG. 8, the wireless communication system 100 (or the AP device 110 and the non-AP STA device 120 therein) may operate according to the second coherent puncturing control scheme to achieve better overall performance, and more particularly, perform the preamble puncturing with the coherent puncturing. The AP device 110 may perform the enhanced preamble puncturing, such as the preamble puncturing with the soft puncturing or simply the hard puncturing, as well as the coherent puncturing on the first PPDU such as the PPDU 721 (labeled “Primary-channel soft preamble puncture” for brevity) to access the channel(s) with the alignment of the interference duration, for example, by aligning the puncturing duration with the adjacent channel interference duration such as the duration of the adjacent channel interference, and further perform the full bandwidth transmission of the subsequent PPDU 722 (labeled “Full bandwidth TX” for brevity) to access the channel(s) with a larger bandwidth such as the full bandwidth. For brevity, similar descriptions for this embodiment are not repeated in detail here.

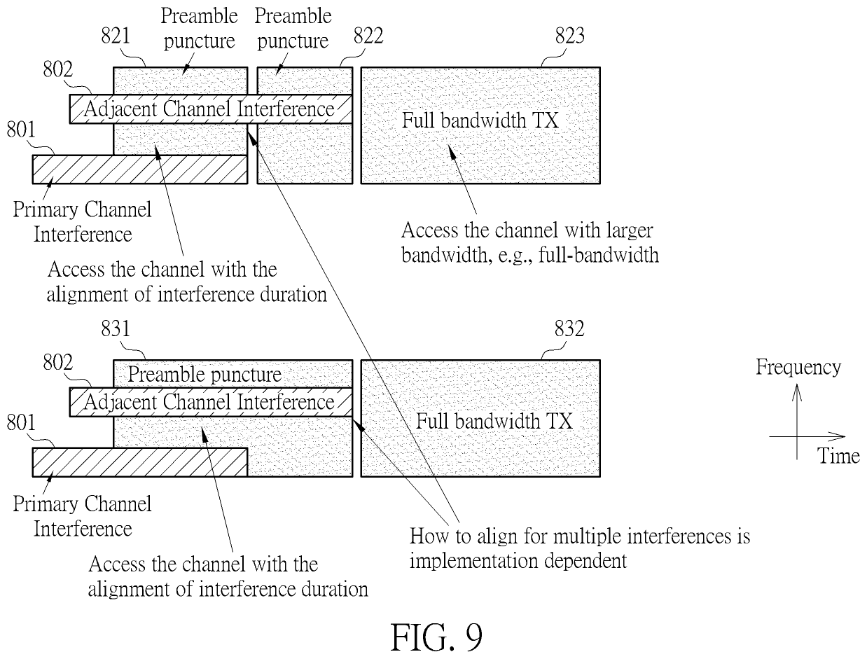

FIG. 9 illustrates, in the upper half part and the lower half part thereof, a third coherent puncturing control scheme and a fourth coherent puncturing control scheme of the method according to an embodiment of the present invention. In a special case that multiple interferences such as both of the primary channel interfere 801 (e.g., the primary channel interfere 701 shown in FIG. 8) and the adjacent channel interfere 802 (e.g., the adjacent channel interfere 601 shown in FIG. 7) exists, the PPDUs 821, 822 and 823 of the third coherent puncturing control scheme and the PPDUs 831 and 832 of the fourth coherent puncturing control scheme may be illustrated as shown in FIG. 9 to replace the PPDUs in the previous embodiments, for indicating the associated operations. Please note that how to align for the multiple interferences may be implementation dependent, where the performance corresponding to the third coherent puncturing control scheme would be better than the performance corresponding to the fourth coherent puncturing control scheme since the timing transmitting or receiving real data via the primary channel can be earlier in the third coherent puncturing control scheme. For brevity, similar descriptions for this embodiment are not repeated in detail here.

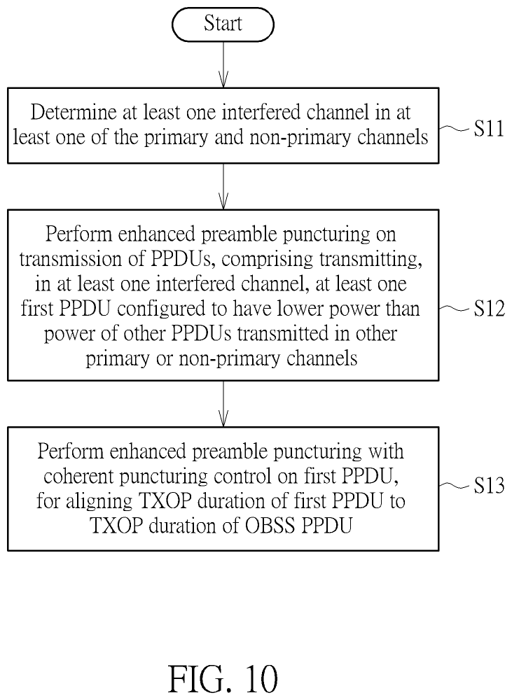

FIG. 10 illustrates a working flow of the method according to an embodiment of the present invention. The method can be applied to the wireless communication system 100, and more particularly, can be applied to the wireless transceiver device #n and the aforementioned at least one other wireless transceiver device #n′, such as the AP device 110 and the non-AP STA device 120, or the AP device 110 and the other AP device among the multiple AP devices {110}, but the present invention is not limited thereto.
In Step S11, the wireless transceiver device #n may determine the aforementioned at least one interfered channel in the aforementioned at least one of the primary and non-primary channels.
In Step S12, the wireless transceiver device #n may perform the enhanced preamble puncturing on the transmission of the PPDUs, comprising transmitting, in the aforementioned at least one interfered channel, the aforementioned at least one first PPDU configured to have the lower power than the power of the other PPDUs transmitted in the other primary or non-primary channels.
In Step S13, the wireless transceiver device #n may perform the enhanced preamble puncturing with the coherent puncturing control on the first PPDU, for aligning the first TXOP duration of the first PPDU to the TXOP duration of the OBSS PPDU, for example, by controlling the first TXOP duration to make the first PPDU be ended just before (or slightly before) the OBSS PPDU is ended, for gaining the one or more wider bandwidth channel access opportunities.

For better comprehension, the method may be illustrated with the working flow shown in FIG. 10, but the present invention is not limited thereto. According to some embodiments, one or more steps may be added, deleted, or changed in the working flow shown in FIG. 10.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing enhanced preamble puncturing in a wireless communication system, wherein the wireless communication system comprises a first wireless transceiver device having an enhanced preamble puncturing capability, wherein the first wireless transceiver device is configured to operate in a first transmission bandwidth comprising one primary and multiple non-primary channels, the method comprising:
determining at least one interfered channel in at least one of the primary and non-primary channels; and
performing the enhanced preamble puncturing on transmission of physical layer (PHY) protocol data units (PPDUs) comprising transmitting, in the at least one interfered channel, at least one first PHY protocol data unit (PPDU) configured to have a lower power than a power of other PPDUs transmitted in other primary or non-primary channels.

2. The method of claim 1, wherein the first wireless transceiver device is arranged to send at least one indication for indicating at least one capability regarding the enhanced preamble puncturing.

3. The method of claim 1, wherein the at least one interfered channel comprises one or more 20 megahertz (20 MHz) channels, and the at least one first PPDU comprises one or more signals on the one or more 20 MHz channels; and during the enhanced preamble puncturing, the one or more signals on the one or more 20 MHz channels are transmitted with the lower power, wherein the lower power comprises at least one lower transmit power that is lower than any transmit power of any signals on any other 20 MHz channels within the primary and non-primary channels.

4. The method of claim 1, wherein the at least one interfered channel comprises one or more 20 megahertz (20 MHz) channels; and during the enhanced preamble puncturing, the at least one first PPDU is further configured to have a predetermined data portion transmitted in the primary channel among the one or more 20 MHz channels.

5. The method of claim 4, wherein the predetermined data portion includes zero-padded bits or dummy bits.

6. The method of claim 3, wherein the one or more signals comprise a first signal on a first 20 MHz channel among the one or more 20 MHz channels, the first signal being transmitted with transmit power control for mitigation of at least one on-going PPDU transmitted from an overlapped basic service set (OBSS) that causes the determination of the at least one interfered channel.

7. The method of claim 3, wherein the one or more signals comprise same preamble contents as that of the any signals on the any other 20 MHz channels.

8. The method of claim 3, wherein the one or more signals have at least one preamble signaling content which is different from at least one corresponding preamble content of the any signals on the any other 20 MHz channels.

9. The method of claim 8, wherein the at least one preamble signaling content comprises one or a combination of a field value in a high efficiency (HE) signal B (HE-SIG-B) field within a first PHY header of the first PPDU and a field value in an extremely high throughput (EHT) signal (EHT-SIG) field within the first PHY header.

10. The method of claim 3, wherein the at least one interfered channel includes a 40 megahertz (40 MHz) primary channel, and the at least one first PPDU, transmitting in the at least one interfered channel, has a preamble having repeated fields.

11. The method of claim 10, wherein the repeated fields are non-high-throughput (non-HT) short training fields (L-STF fields), and each L-STF field among the L-STF fields is the same as a L-STF field in a PPDU transmitted in at least one other 20 MHz channel.

12. The method of claim 3, wherein the at least one interfered channel includes a 40 MHz primary channel, and the at least one first PPDU, transmitting in the at least one interfered channel, has a plurality of repeated preambles.

13. The method of claim 1, wherein performing the enhanced preamble puncturing on the transmission of the PPDUs further comprises:
performing the enhanced preamble puncturing with coherent puncturing control on any first PPDU among the at least one first PPDU, for aligning a first transmission opportunity (TXOP) duration of the any first PPDU to a TXOP duration of an overlapping basic service set (OBSS) PPDU.

14. The method of claim 13, wherein the coherent puncturing control comprises controlling the first TXOP duration to make the any first PPDU be ended just before the OBSS PPDU is ended, for gaining one or more wider bandwidth channel access opportunities.

15. The method of claim 14, wherein the coherent puncturing control further comprises estimating the TXOP duration of the OBSS PPDU according to at least one preamble content of the OBSS PPDU.

16. The method of claim 15, wherein the at least one preamble content comprises one or a combination of a field value in a non-high-throughput (non-HT) signal (L-SIG) field within an OBSS PHY header of the OBSS PPDU, a field value in a high efficiency (HE) signal A (HE-SIG-A) field within the OBSS PHY header, and a field value in an extremely high throughput (EHT) signal (EHT-SIG) field within the OBSS PHY header.

17. The method of claim 13, wherein the coherent puncturing control further comprises aligning the first TXOP duration of the any first PPDU to the TXOP duration of the OBSS PPDU which occupied a primary channel among a set of 20 megahertz (20 MHz) channels within the primary and non-primary channels.

18. A wireless transceiver device, for performing enhanced preamble puncturing in a wireless communication system, the wireless transceiver device comprising:
a processing circuit, arranged to control operations of the wireless transceiver device; and
at least one communication control circuit, coupled to the processing circuit, arranged to perform communication control, wherein the at least one communication control circuit is arranged to perform wireless communication operations with at least one other device within the wireless communication system for the wireless transceiver device, wherein the wireless transceiver device having an enhanced preamble puncturing capability is configured to operate in a first transmission bandwidth comprising one primary and multiple non-primary channels;
wherein:
the wireless transceiver device is arranged to determine at least one interfered channel in at least one of the primary and non-primary channels; and
the wireless transceiver device is arranged to perform the enhanced preamble puncturing on transmission of PPDUs comprising transmitting, in the at least one interfered channel, at least one first physical layer (PHY) protocol data unit (PPDU) configured to have a lower power than a power of other PPDUs transmitted in other primary or non-primary channels.
